(19) United States
(12) Patent Application Publication
(10) Pub. No.: US 2021/0035438 A1
(43) Pub. Date: Feb. 4, 2021

(54) PEDESTRIAN MANAGEMENT SYSTEMS AND METHODS

(71) Applicant: Ford Global Technologies, LLC, Dearborn, MI (US)

(72) Inventors: Oswaldo PEREZ BARRERA, Dearborn, MI (US); David Franco LOPEZ RUBIO, Dearborn, MI (US); Hedy H. MORALES BOLANOS, Dearborn, MI (US); Rodrigo C. FRIEVENTH, Dearborn, MI (US)

(21) Appl. No.: 16/966,160

(22) PCT Filed: Feb. 9, 2018
(86) PCT No.: PCT/US2018/017583

§ 371 Date: Jul. 30, 2020

(51) Int. Cl. G08G 1/005; G08G 1/16; G08G 1/01; G08G 1/09

(52) U.S. Cl. CPC G08G 1/005; G08G 1/091; G08G 1/0112; G08G 1/166

(57) ABSTRACT

Example pedestrian management systems and methods are described. In one implementation, a method identifies a pedestrian approaching a known pedestrian crossing location. A pedestrian management system notifies an approaching vehicle that the pedestrian wants to cross a road in front of the approaching vehicle. The approaching vehicle determines whether the pedestrian has sufficient time to cross the road ahead of the vehicle. The pedestrian management system then notifies the pedestrian whether they can cross the road ahead of the vehicle.

### TECHNICAL FIELD

The present disclosure relates to systems and methods that assist pedestrians crossing a road.

### BACKGROUND

In many scenarios, vehicles driving on a road need to interact with pedestrians walking near a road or attempting to cross the road. When the vehicle is an autonomous vehicle, pedestrians are not able to see a driver's gesture or otherwise communicate with a human driver of the vehicle. Without good communication between autonomous vehicles and pedestrians, accidents may occur.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting an environment within which an example embodiment may be implemented.

FIG. 2 is a block diagram illustrating an embodiment of a vehicle driving on a road and approaching a known pedestrian crossing location.

FIG. 3 is a block diagram illustrating an embodiment of a pedestrian management system.

FIG. 4 is a block diagram illustrating an embodiment of a vehicle management system.

FIGS. 5A-5B illustrate an embodiment of a method for notifying a pedestrian whether it is safe to cross a road at a known pedestrian crossing location.

FIG. 6 illustrates an embodiment of a method for determining whether a pedestrian has enough time to cross a road ahead of an approaching vehicle.

FIG. 7 illustrates an example block diagram of a computing device.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

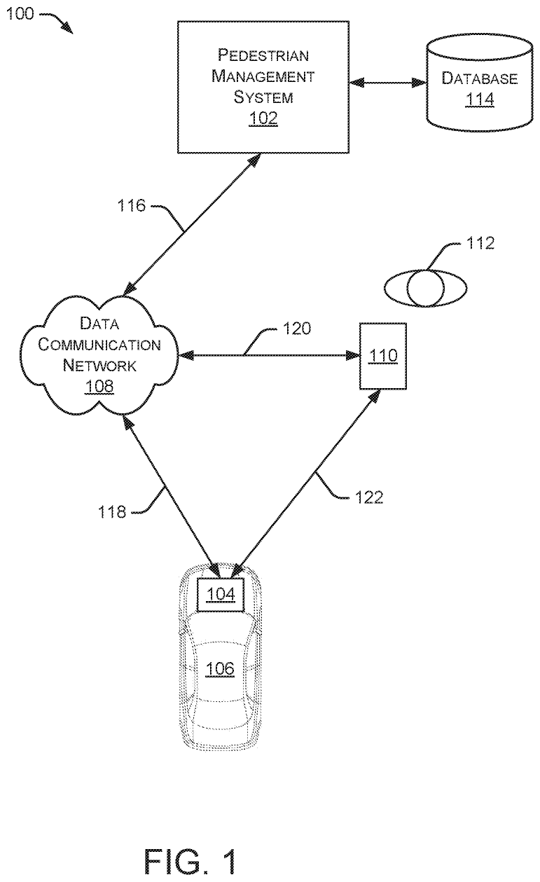

FIG. 1 is a block diagram depicting an environment 100 within which an example embodiment may be implemented. In some embodiments, a pedestrian management system 102 communicates with a vehicle 106 and a device 110 carried by or worn by a user 112. In the example of FIG. 1, pedestrian management system 102 communicates with vehicle 106 and device 110 via a data communication network 108. Data communication network 108 includes any type of network topology using any communication protocol. Additionally, data communication network 108 may include a combination of two or more communication networks. In some embodiments, data communication network 108 includes a cellular communication network, the Internet, a local area network, a wide area network, or any other communication network.

As discussed herein, pedestrian management system 102 performs various functions to determine whether a pedestrian (e.g., user 112) can safely cross a road ahead of an approaching vehicle (e.g., vehicle 106). The functions include detecting when user 112 approaches a known pedestrian crossing location, communicating with vehicle 106 to determine whether it is safe for user 112 to cross the road, and communicating with device 110 to indicate to user 112 whether they can cross the road or wait for vehicle 106 to pass. Pedestrian management system 102 is coupled to a database 114 that contains information related to known pedestrian crossing locations (e.g., crosswalks and other pedestrian walkways), road information (e.g., road speed limits and historical accident information), sidewalk information, historical data associated with user 112, and the like. In some embodiments, known pedestrian crossing locations may include locations where people commonly jaywalk or otherwise commonly cross the road improperly.

Device 110 includes any type of computing device carried by user 112 or worn by user 112, such as a mobile device or a wearable device. Example mobile devices include smartphones, tablet computing devices, and the like. Example wearable devices include smart watches, activity trackers, and the like. As used herein, device 110 is any type of computing device capable of communicating with or providing information to user 112. In some embodiments, device 110 executes an app (e.g., application) that allows device 110 to communicate with pedestrian management system 102.

In some embodiments, vehicle 106 is an autonomous vehicle. Vehicle 106 includes a vehicle management system 104 that controls various vehicle operations, such as automated driving systems, driving assistance systems, climate control systems, engine control systems, suspension control systems, infotainment systems, collision avoidance systems, and the like. As described herein, vehicle management system 104 is capable of determining whether a pedestrian (e.g., user 112) can safely cross a road ahead of vehicle 106 and communicating that information to pedestrian management system 102. In some embodiments, vehicle 106 includes various sensors and components that detect the location of the pedestrian and the anticipated location at which the pedestrian wants to cross the road. Example sensors and components include Radar (radio detection and ranging) systems, Lidar (light detection and ranging) systems, camera systems, Ultrasound systems, GPS (Global Positioning Systems), and the like.

As shown in FIG. 1, pedestrian management system 102 communicates with data communication network 108 via communication link 116, vehicle management system 104 communicates with data communication network 108 via communication link 118, and device 110 communicates with data communication network 108 via communication link 120. Any communication protocol may be used for communications between data communication network 108 and pedestrian management system 102, vehicle management system 104, and device 110. For example, the communications may use 3G, 4G LTE, WiFi, and the like. In some embodiments, vehicle management system 104 may communicate with device 110 directly via communication link 122 using 3G, 4G LTE, WiFi, and the like. In this situation, vehicle management system 104 may perform some of the functions described herein as being performed by pedestrian management system 102.

It will be appreciated that the embodiment of FIG. 1 is given by way of example only. Other embodiments may include fewer or additional components without departing from the scope of the disclosure. Additionally, illustrated components may be combined or included within other components without limitation.

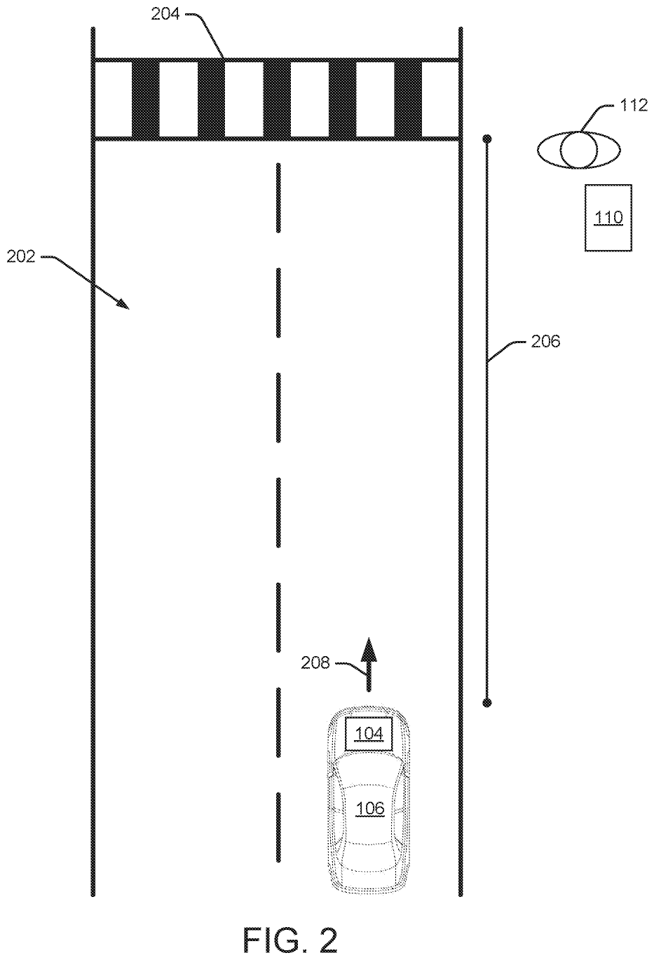

FIG. 2 is a block diagram illustrating an embodiment of vehicle 106 driving on a road 202 and approaching a known pedestrian crossing location 204. The embodiment of FIG. 2 also illustrates user 112 (e.g., pedestrian) and device 110 carried or worn by user 112. As shown in FIG. 2, vehicle 106 is driving along road 202 in a direction indicated by arrow 208. In this example, vehicle 106 is an autonomous vehicle and includes vehicle management system 104, as discussed herein. Vehicle 106 is approaching a known pedestrian crossing location 204. Information related to known pedestrian crossing locations may be stored in database 114 and communicated from pedestrian management system 102 to other systems, such as vehicle management system 104 or device 110.

The distance between vehicle 106 and known pedestrian crossing location 204 is indicated by a line 206. This distance can be determined, for example, based on GPS data or any other sensor data, such as camera data, Radar data, Lidar data, Ultrasound data, or any combination thereof. The distance between vehicle 106 and known pedestrian crossing location 204 is used, as discussed herein, by vehicle management system 104 to determine whether user 112 can safely cross road 202 using known pedestrian crossing location 204 ahead of vehicle 106. In other embodiments, the distance between vehicle 106 and known pedestrian crossing location 204 is used by pedestrian management system 102 to determine whether user 112 can safely cross road 202 using known pedestrian crossing location 204 ahead of vehicle 106. In further embodiments, the distance between vehicle 106 and known pedestrian crossing location 204 is used by device 110 to determine whether user 112 can safely cross road 202 using known pedestrian crossing location 204 ahead of vehicle 106.

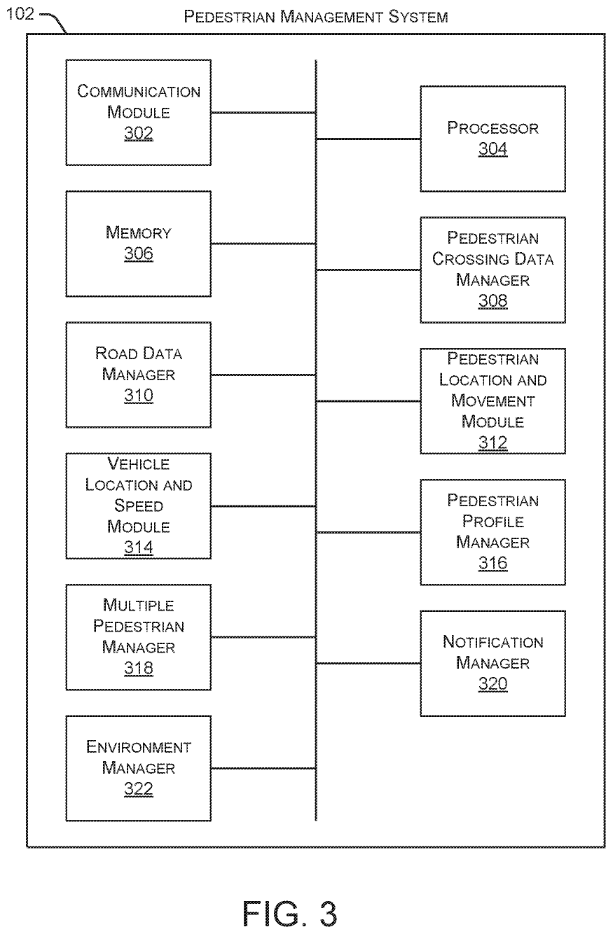

FIG. 3 is a block diagram illustrating an embodiment of pedestrian management system 102. As shown in FIG. 3, pedestrian management system 102 includes a communication module 302, a processor 304, and a memory 306. Communication module 302 allows pedestrian management system 102 to communicate with other systems and devices, such as database 114, device 110, data communication network 108, vehicle management system 104, and the like. Processor 304 executes various instructions to implement the functionality provided by pedestrian management system 102, as discussed herein. Memory 306 stores these instructions as well as other data used by processor 304 and other modules and components contained in pedestrian management system 102.

Pedestrian management system 102 also includes a pedestrian crossing data manager 308 that manages information associated with known pedestrian crossing locations. For example, pedestrian crossing data manager 308 may receive and manage new or updated pedestrian crossing location information. The pedestrian crossing location information may include specific geographic coordinates associated with each known pedestrian crossing location. A road data manager 310 manages information related to roads, intersections, and the like. For example road data manager 310 may receive and manage new or updated road information. The road information may include a number of lanes, speed limit, road boundaries, and the like.

A pedestrian location and movement module 312 monitors one or more pedestrians, such as pedestrians walking on a sidewalk and approaching a known pedestrian crossing location. In some embodiments, pedestrian location and movement module 312 detects pedestrians who walk toward a known pedestrian crossing location and come to a stop at the known pedestrian crossing location, thereby indicating a desire to cross the road. Additionally, pedestrian location and movement module 312 can monitor one or more pedestrians actively crossing a road at a known pedestrian crossing location. For example, pedestrian location and movement module 312 may monitor pedestrians until they have safely crossed the road. In some embodiments device 110 carried by or worn by pedestrian 112 detects movement (or lack of movement) of pedestrian 112 and communicates that information regarding movement to pedestrian management system 102.

Pedestrian management system 102 also includes a vehicle location and speed module 314 that determines locations of vehicles on a road and the speed that each vehicle is traveling. In some embodiments, vehicle location and speed module 314 estimates the time for the vehicle to reach the known pedestrian crossing location based on the vehicle speed, the location of the vehicle, and the location of the known pedestrian crossing location.

A pedestrian profile manager 316 manages the storage and retrieval of profile information associated with any number of pedestrians. Example profile information includes a pedestrian's name and age. The profile information may also include historical information regarding how quickly the pedestrian has crossed other roads (or how quickly the pedestrian has previously crossed the same road). For example, if a particular pedestrian has previously been slow to cross a road (i.e., slower than an average pedestrian), that information may be used in determining whether the particular pedestrian can cross a road ahead of an approaching vehicle. Pedestrian profile manager 316 may communicate the profile information to other systems and components that determine whether a pedestrian should attempt to cross a road ahead of an approaching vehicle. Additionally, pedestrian profile manager 316 may update a pedestrian's historical road crossing information each time the pedestrian completes a road crossing activity. In some embodiments, pedestrians may register with or provide identification information to pedestrian management system 102 such that pedestrian management system 102 can uniquely identify each pedestrian. For example, a particular pedestrian may be uniquely identified based on an identifier associated with device 110 carried by or worn by the pedestrian.

Pedestrian management system 102 also includes a multiple pedestrian manager 318 that detects the presence of multiple pedestrians wanting to simultaneously cross a road at the same location. In this situation, it may take the multiple pedestrians longer to cross the road than a single pedestrian. This information is used in determining whether the multiple pedestrians can cross the road ahead of an approaching vehicle. For example, it may take a small group of pedestrians (1-5 pedestrians) 10 seconds to cross the road, but may take a larger group of pedestrians (6-10 pedestrians) 15 seconds to cross the same road. Even larger groups of pedestrians (more than 10 pedestrians) may take 20 seconds or longer to cross the same road.

A notification manager 320 manages the communication of notification messages (or alerts) to one or more pedestrians. The notification messages may include one or more of a visual notification, an audio notification, and a haptic notification. In some embodiments, the notification messages are communicated to device 110 carried by or worn by pedestrian (e.g., user) 112. The notification messages may indicate that pedestrian 112 should not attempt to cross the road or that pedestrian 112 can cross the road ahead of the approaching vehicle. Other notification messages may provide an indication of whether pedestrian 112 should increase their speed as they cross the road. For example, if pedestrian 112 is moving slower than expected, notification manager 320 may prompt pedestrian 112 to increase their speed. In some embodiments, if pedestrian 112 is moving slower than expected, notification manager 320 may communicate a message to the approaching vehicle indicating that the vehicle should slow down or closely monitor pedestrian 112 crossing in front of the vehicle.

An environment manager 322 identifies current environment conditions, such as light level, dry road surface, wet road surface, rain, snow, fog, wind, and the like. These environmental conditions may impact the speed at which a pedestrian crosses the road. For example, a wet or snow-covered road surface may slow down the rate at which the pedestrian crosses the road. These environmental conditions may be used in determining whether a particular pedestrian can cross a road ahead of an approaching vehicle. The environmental conditions can be determined based on one or more sensors located near the known pedestrian crossing location, one or more sensors associated with vehicle 106, online weather data sources, and the like. Environment manager 322 may communicate the environmental conditions to other systems and components that determine whether a pedestrian should attempt to cross a road ahead of an approaching vehicle. In some embodiments, environment manager 322 stores information related to the time it takes pedestrians to cross a particular road in different environmental conditions.

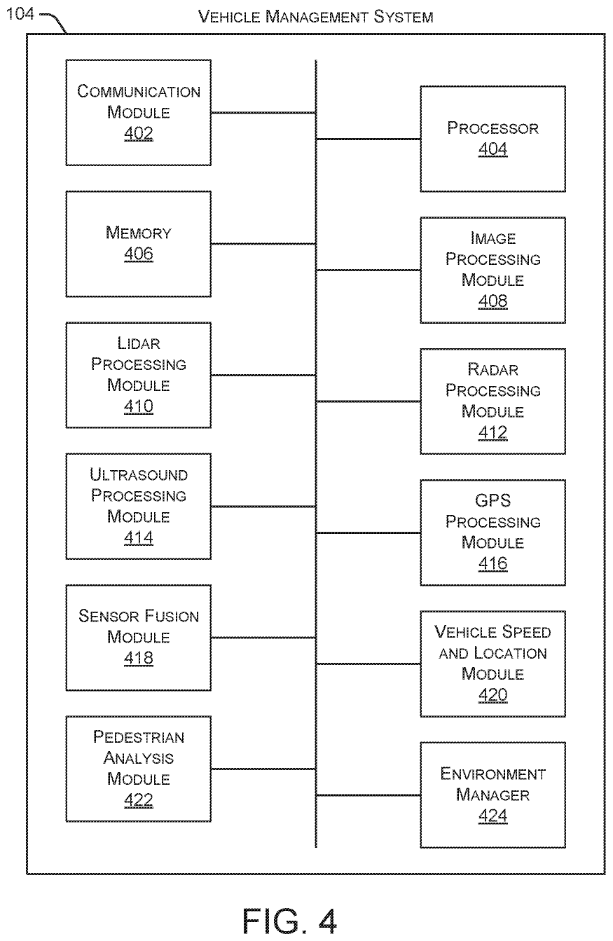

FIG. 4 is a block diagram illustrating an embodiment of vehicle management system 104. As shown in FIG. 4, vehicle management system 104 includes a communication module 402, a processor 404, and a memory 406. Communication module 402 allows vehicle management system 104 to communicate with other systems and devices, such as pedestrian management system 102, database 114, device 110, data communication network 108, and the like. Processor 404 executes various instructions to implement the functionality provided by vehicle management system 104, as discussed herein. Memory 406 stores these instructions as well as other data used by processor 404 and other modules and components contained in vehicle management system 104.

As mentioned above, some embodiments of vehicle 106 (which contains vehicle management system 104) include multiple sensors and components that detect the location of a pedestrian and the anticipated location at which the pedestrian wants to cross the road. For example, sensors and components may include Radar systems, Lidar systems, camera systems, Ultrasound systems, GPS (Global Positioning Systems), and the like.

Vehicle management system 104 also includes an image processing module 408 that analyzes images captured by one or more cameras associated with vehicle 106. For example, image processing module 408 may identify one or more pedestrians in the captured images. A Lidar processing module 410 receives Lidar data from one or more Lidar sensors or Lidar systems associated with vehicle 106. A Radar processing module 412 receives Radar data from one or more Radar sensors or Radar systems associated with vehicle 106. An Ultrasound processing module 414 receives Ultrasound data from one or more Ultrasound sensors or Ultrasound systems associated with vehicle 106. A GPS processing module 416 receives GPS data from one or more GPS sensors or GPS systems associated with vehicle 106.

Vehicle management system 104 further includes a sensor fusion module 418 that fuses data from multiple sensors, cameras, and data sources, as discussed herein. For example, sensor fusion module 418 may fuse data from one or more cameras, one or more Lidar systems, one or more Radar systems, one or more Ultrasound systems, and one or more GPS devices. Sensor fusion module 418 fuses data from the multiple sensors, cameras, and data sources to identify one or more pedestrians ahead of vehicle 106.

A vehicle speed and location module 420 determines a current speed and geographic location of vehicle 106. As discussed herein, the current vehicle speed and geographic location information is used to determine a distance between vehicle 106 and one or more pedestrians ahead of vehicle 106. Based on that distance and the speed of vehicle 106, the systems and methods described herein can estimate a time until vehicle 106 reaches the location of the pedestrian.

A pedestrian analysis module 422 analyzes various data collected from one or more sensors, cameras, and data sources, as discussed herein. In some embodiments, pedestrian analysis module 422 monitors the location and movement of one or more pedestrians ahead of vehicle 106. An environment manager 424 identifies current environment conditions, such as light level, dry road surface, wet road surface, rain, snow, fog, wind, and the like. The operation of environment manager 424 may be substantially similar to the operation of environment manager 322 discussed herein.

Some embodiments of vehicle management system 104 include a notification manager (similar to notification manager 320 discussed herein) that allows vehicle management system 104 to send notifications to one or more pedestrians directly (e.g., not communicated through pedestrian management system 102).

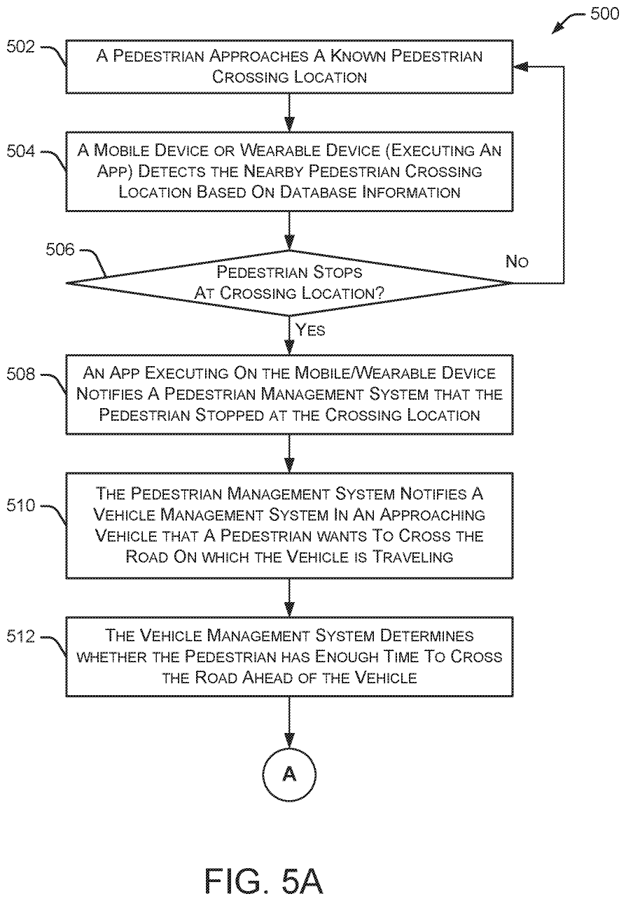

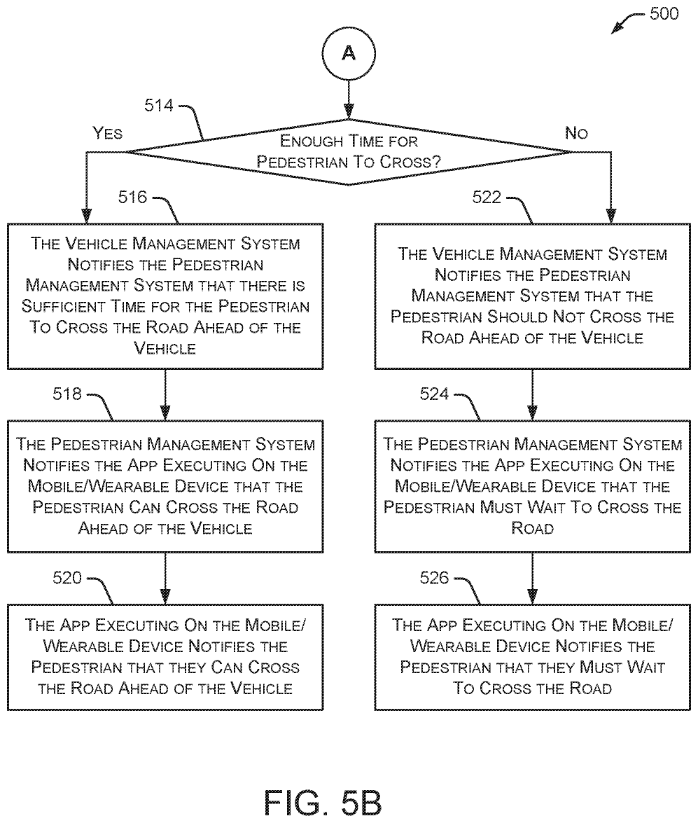

FIGS. 5A-5B illustrate an embodiment of a method 500 for notifying a pedestrian whether it is safe to cross a road at a known pedestrian crossing location. Initially, a pedestrian approaches 502 a known pedestrian crossing location. A device (such as a mobile device carried by the pedestrian or a wearable device worn by the pedestrian) detects 504 the nearby pedestrian crossing location based on database information. For example, the device carried by or worn by the pedestrian may temporarily store at least a portion of the known pedestrian crossing location data contained in database 114 (FIG. 1). In some embodiments, the device carried by or worn by the pedestrian regularly communicates its current geographic location to pedestrian management system 102 so that pedestrian management system 102 can determine whether the pedestrian is approaching a crossing location.

Method 500 continues by determining 506 whether the pedestrian stops at a known pedestrian crossing location. In some embodiments, determining whether the pedestrian stops at a known pedestrian crossing location includes identifying that the pedestrian is proximate a known pedestrian crossing location and the location of the pedestrian does not change for a particular time period, such as a few seconds. In particular implementations, if there are two or more known pedestrian crossing locations proximate the pedestrian, pedestrian management system 102 may determine the pedestrians desired crossing location based on the direction the pedestrian is facing. For example, the direction that the pedestrian is currently facing can be determined based on the mobile device carried by or worn by the pedestrian. If the pedestrian does not stop at a crossing location (e.g., the pedestrian continues walking past the known pedestrian crossing location), the method returns to 502 to continue monitoring the same pedestrian and/or other pedestrians approaching a known pedestrian crossing location.

If, at 506, the pedestrian does stop at the crossing location, it likely indicates the pedestrian's intention to cross a road at the crossing location. In this situation, an app (i.e., application) executing on the mobile/wearable device notifies 508 a pedestrian management system that the pedestrian stopped at the crossing location. In some embodiments, a pedestrian management itself (such as pedestrian management system 102) detects that the pedestrian has stopped at the crossing location.

The pedestrian management system then notifies 510 a vehicle management system in an approaching vehicle that a pedestrian wants to cross the road on which the vehicle is traveling. In some embodiments, the pedestrian management system also communicates information about the pedestrian (e.g., geographic location of the pedestrian, profile information associated with the pedestrian, and the like) to the vehicle management system in the approaching vehicle. The vehicle management system then determines 512 whether the pedestrian has enough time to cross the road ahead of the vehicle. As discussed herein, this determination can be based on one or more factors, such as the speed of the vehicle, the distance from the vehicle to the crossing location, current environmental conditions, information about the pedestrian (historical data related to how fast the pedestrian has previously crossed roads, etc.), the number of pedestrians, and the like. In some embodiments, the vehicle management system may communicate information related to the one or more factors to the pedestrian management system, then the pedestrian management system determines whether the pedestrian has enough time to cross the road ahead of the vehicle.

If the pedestrian does has enough time to cross the road ahead of the vehicle 514, the method continues to 516 where the vehicle management system notifies the pedestrian management system that there is sufficient time for the pedestrian to cross the road ahead of the vehicle. Upon receiving the notification from the vehicle management system, the pedestrian management system notifies 518 the app executing on the mobile/wearable device that the pedestrian can cross the road ahead of the vehicle. The app executing on the mobile/wearable device then notifies 520 the pedestrian carrying or wearing the device that they can cross the road ahead of the vehicle. As discussed herein, this notification to the pedestrian may include one or more of a visual notification, an audio notification, and a haptic notification. For example, the notification to the pedestrian may be an audible message such as “You can safely cross the road” or a visual message with the same information. In some embodiments, a haptic notification (e.g., a vibration) is provided to the pedestrian by device 110 to indicate the time left to cross the road before the approaching vehicle arrives at the pedestrian crossing location. For example, when the pedestrian has 10 seconds remaining to cross the road, device 10 may vibrate at a rate of two vibrations per second. As the remaining time to cross the road decreases, the vibration rate increases to indicate an increasing urgency to the pedestrian. For example, when the pedestrian has 5 seconds remaining to cross the road, device 10 may vibrate at a rate of seven vibrations per second.

If the pedestrian does not has enough time to cross the road ahead of the vehicle 514, the method continues to 522 where the vehicle management system notifies the pedestrian management system that the pedestrian should not cross the road ahead of the vehicle. Upon receiving the notification from the vehicle management system, the pedestrian management system notifies 524 the app executing on the mobile/wearable device that the pedestrian must wait to cross the road. The app executing on the mobile/wearable device then notifies 526 the pedestrian carrying or wearing the device that they must wait to cross the road. As discussed herein, this notification to the pedestrian may include one or more of a visual notification, an audio notification, and a haptic notification. For example, the notification to the pedestrian may be an audible message such as “Do not cross the road” or a visual message with the same information.

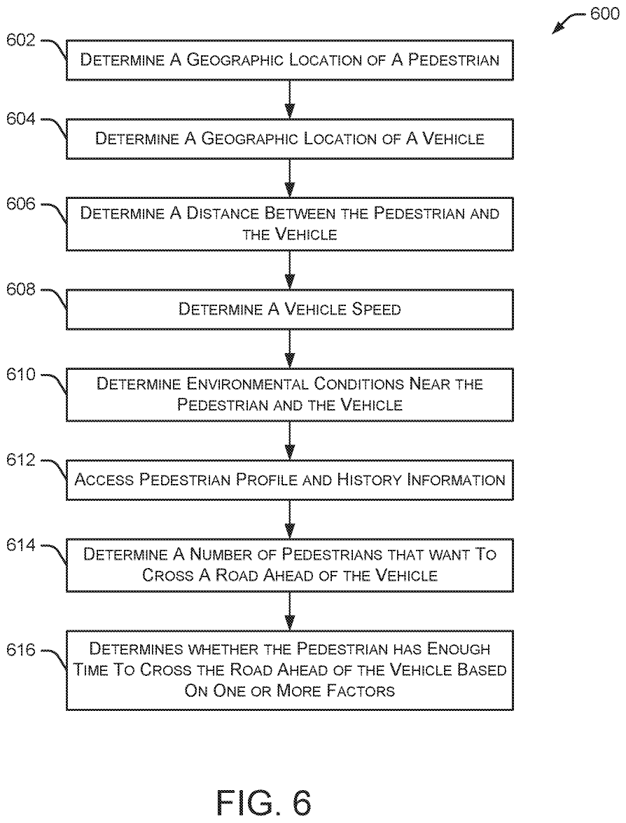

FIG. 6 illustrates an embodiment of a method 600 for determining whether a pedestrian has enough time to cross a road ahead of an approaching vehicle. Initially, method 600 determines 602 a geographic location of a pedestrian and determines 604 a geographic location of a vehicle. Based on the geographic locations of the pedestrian and the vehicle, the method determines 606 a distance between the pedestrian and the vehicle. Method 600 then determines 608 a vehicle speed and determines 610 environmental conditions near the pedestrian and the vehicle. In some embodiments, the method accesses 612 pedestrian profile and history information, as discussed herein. For example, a pedestrian profile may include the age of the pedestrian, which is used to determine the time it may take the pedestrian to cross the road. For example, if a pedestrian is 18-40 years old, they may be expected to cross a particular road in 10 seconds. However, a pedestrian over the age of 60 may be expected to take longer to cross the same road, such as 15 seconds.

Method 600 also determines 614 a number of pedestrians that want to cross a road ahead of the vehicle. In some embodiments, the number of pedestrians is determined using one or more sensors or cameras associated with the vehicle. In other embodiments, the number of pedestrians is determined using other sensors located near the known pedestrian crossing location. Additionally, the number of pedestrians may be determined based on communications between pedestrian management system 102 and multiple devices 110 carried by or worn by multiple pedestrians 112. Method 600 then determines 616 whether the pedestrian (or multiple pedestrians) has enough time to cross the road ahead of the vehicle based on one or more of the above factors. In some embodiments, method 600 may include fewer or additional steps without departing from the scope of the disclosure. Additionally, illustrated steps may be combined or included within other steps without limitation.

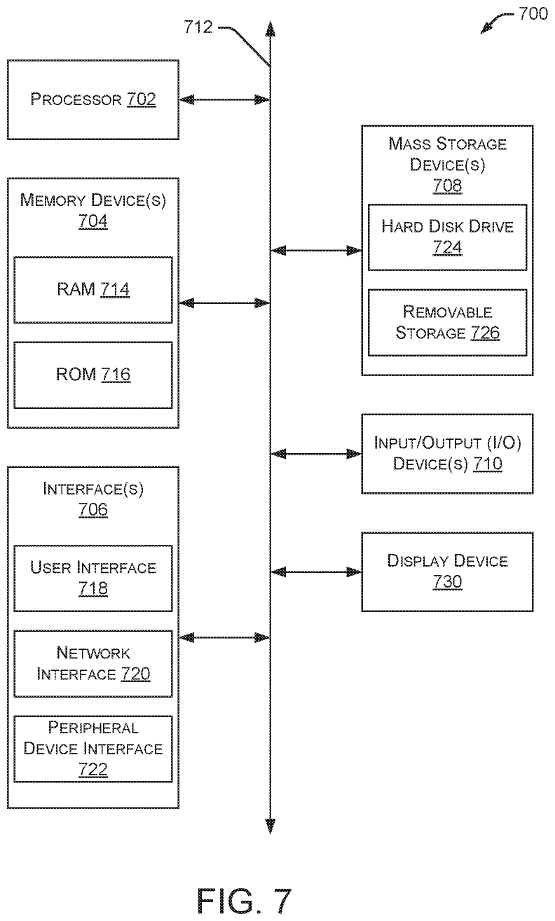

FIG. 7 illustrates an example block diagram of a computing device 700. Computing device 700 may be used to perform various procedures, such as those discussed herein. A computing device 700 may perform any of the functions or methods of the pedestrian management system 102, vehicle management system 104, device 110, and/or any other computing entity. Computing device 700 can perform various delivery functions as discussed herein, and can execute one or more application programs, such as the application programs or functionality described herein. Computing device 700 can be any of a wide variety of computing devices, such as a desktop computer, in-dash computer, vehicle control system, a notebook computer, a server computer, a handheld computer, tablet computer, a wearable device, and the like.

Computing device 700 includes one or more processor(s) 702, one or more memory device(s) 704, one or more interface(s) 706, one or more mass storage device(s) 708, one or more Input/Output (I/O) device(s) 710, and a display device 730 all of which are coupled to a bus 712. Processor(s) 702 include one or more processors or controllers that execute instructions stored in memory device(s) 704 and/or mass storage device(s) 708. Processor(s) 702 may also include various types of computer-readable media, such as cache memory.

Memory device(s) 704 include various computer-readable media, such as volatile memory (e.g., random access memory (RAM) 714) and/or nonvolatile memory (e.g., read-only memory (ROM) 716). Memory device(s) 704 may also include rewritable ROM, such as Flash memory.

Mass storage device(s) 708 include various computer readable media, such as magnetic tapes, magnetic disks, optical disks, solid-state memory (e.g., Flash memory), and so forth. As shown in FIG. 7, a particular mass storage device is a hard disk drive 724. Various drives may also be included in mass storage device(s) 708 to enable reading from and/or writing to the various computer readable media. Mass storage device(s) 708 include removable media 726 and/or non-removable media.

I/O device(s) 710 include various devices that allow data and/or other information to be input to or retrieved from computing device 700. Example I/O device(s) 710 include cursor control devices, keyboards, keypads, microphones, monitors or other display devices, speakers, printers, network interface cards, modems, and the like.

Display device 730 includes any type of device capable of displaying information to one or more users of computing device 700. Examples of display device 730 include a monitor, display terminal, video projection device, and the like.

Interface(s) 706 include various interfaces that allow computing device 700 to interact with other systems, devices, or computing environments. Example interface(s) 706 may include any number of different network interfaces 720, such as interfaces to local area networks (LANs), wide area networks (WANs), wireless networks, and the Internet. Other interface(s) include user interface 718 and peripheral device interface 722. The interface(s) 706 may also include one or more user interface elements 718. The interface(s) 706 may also include one or more peripheral interfaces such as interfaces for printers, pointing devices (mice, track pad, or any suitable user interface now known to those of ordinary skill in the field, or later discovered), keyboards, and the like.

Bus 712 allows processor(s) 702, memory device(s) 704, interface(s) 706, mass storage device(s) 708, and I/O device(s) 710 to communicate with one another, as well as other devices or components coupled to bus 712. Bus 712 represents one or more of several types of bus structures, such as a system bus, PCI bus, IEEE bus, USB bus, and so forth.

For purposes of illustration, programs and other executable program components are shown herein as discrete blocks, although it is understood that such programs and components may reside at various times in different storage components of computing device 700, and are executed by processor(s) 702. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
identifying a pedestrian approaching a known pedestrian crossing location;
notifying, by a pedestrian management system, an approaching vehicle that the pedestrian wants to cross a road in front of the approaching vehicle, wherein the approaching vehicle determines whether the pedestrian has sufficient time to cross the road; and
notifying, by the pedestrian management system, the pedestrian whether they can cross the road.

2. The method of claim 1, wherein identifying a pedestrian approaching a known pedestrian crossing location includes receiving notification from a device carried or worn by the pedestrian.

3. The method of claim 2, wherein the device carried or worn by the pedestrian includes one of a mobile device, a wearable device, and a computing device.

4. The method of claim 2, wherein the device carried or worn by the pedestrian executes an application that detects known pedestrian crossing locations.

5. The method of claim 2, further comprising the pedestrian management system communicating data associated with known pedestrian crossing locations to the device carried or worn by the pedestrian from a database of known pedestrian crossing locations.

6. The method of claim 1, further comprising detecting, by the pedestrian management system, the pedestrian stopping proximate the known pedestrian crossing location prior to notifying the approaching vehicle that the pedestrian wants to cross the road.

7. The method of claim 1, further comprising receiving by the pedestrian management system, from the approaching vehicle, information regarding whether the pedestrian has sufficient time to cross the road in front of the approaching vehicle.

8. The method of claim 7, wherein notifying the pedestrian whether they can cross the road includes:
generating, by the pedestrian management system, a notification for the pedestrian; and
communicating the notification to a device carried or worn by the pedestrian.

9. The method of claim 1, wherein notifying the pedestrian includes at least one of a visual notification, an audio notification, and a haptic notification.

10. The method of claim 1, wherein determining whether the pedestrian has sufficient time to cross the road includes determining (a) a distance between the pedestrian and the approaching vehicle, and (b) a current speed of the approaching vehicle.

11. The method of claim 1, wherein determining whether the pedestrian has sufficient time to cross the road includes determining at least one of an average time for a pedestrian to cross the road, current environmental conditions that may affect the time necessary to cross the road, a number of pedestrians crossing the road at the same time, and pedestrian profile information.

12. The method of claim 1, further comprising accessing a plurality of known pedestrian crossing locations from a database prior to identifying a pedestrian approaching a known pedestrian crossing location.

13. A method comprising:
receiving, by a vehicle management system in a vehicle driving on a road, information associated with a pedestrian proximate a known pedestrian crossing location, wherein the information includes a geographic location of the pedestrian and an estimated time for the pedestrian to cross the road at the known pedestrian crossing location;
determining, by the vehicle management system, whether the pedestrian has sufficient time to cross the road ahead of the vehicle based on the geographic location of the pedestrian, a geographic location of the vehicle, and a speed of the vehicle; and
communicating, by the vehicle management system, the determination of whether the pedestrian has sufficient time to cross the road ahead of the vehicle to a pedestrian management system.

14. The method of claim 13, wherein the received information associated with the pedestrian includes pedestrian profile data associated with the pedestrian, wherein the pedestrian profile data includes at least one of the pedestrian's name, the pedestrian's age, and historical information regarding how quickly the pedestrian has crossed other roads.

15. The method of claim 13, wherein determining whether the pedestrian has sufficient time to cross the road ahead of the vehicle is further based on at least one current environmental condition.

16. The method of claim 13, wherein determining whether the pedestrian has sufficient time to cross the road ahead of the vehicle further includes determining a distance between the vehicle and the pedestrian based on the geographic location of the pedestrian and a geographic location of the vehicle.

17. The method of claim 13, wherein determining whether the pedestrian has sufficient time to cross the road ahead of the vehicle further includes determining a number of pedestrians that want to cross the road ahead of the vehicle.

18. An apparatus comprising:
a processor; and
a memory device coupled to the processor, the memory device configured to store instructions for execution on the processor, the instructions causing the processor to:
identify a pedestrian approaching a known pedestrian crossing location;
notify an approaching vehicle that the pedestrian wants to cross a road in front of the approaching vehicle, wherein the approaching vehicle determines whether the pedestrian has sufficient time to cross the road;
receive, from the approaching vehicle, an indication of whether the pedestrian has sufficient time to cross the road; and
notify the pedestrian whether they can cross the road.

19. The apparatus of claim 18, further comprising a pedestrian crossing data manager configured to manage known pedestrian crossing locations.

20. The apparatus of claim 18, further comprising a pedestrian profile manager configured to manage the storage and retrieval of profile information associated with a plurality of pedestrians.
